(19) United States
(12) Patent Application Publication
(10) Pub. No.: US 2007/0223570 A1
(43) Pub. Date: Sep. 27, 2007

(54) Distortion Compensating Equalizer

(75) Inventor: Kentaro Goto, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 11/587,372

(22) PCT Filed: Apr. 1, 2005
(86) PCT No.: PCT/JP05/06473

§ 371 Date: Oct. 24, 2006

(30) Foreign Application Priority Data
May 28, 2004 (JP) 2004-159475

(51) Int. Cl. H04B 10/18

(52) U.S. Cl. 375/232

(57) ABSTRACT

A reception-signal adjusting unit adjusts a waveform of a digital reception signal so that amplitude is equally distributed on a positive side and a negative side. A digital filter unit adds a predetermined delay to an input signal by delay elements serially connected as many as taps, multiplies a delay-added signal from each of the delay elements by a corresponding tap coefficient, adds all signals after the multiplication. A CMA-tap-coefficient estimating unit estimates a tap coefficient using a CMA. A distortion in the waveform of the adjusted reception signal is compensated by repeating processes of the digital filter unit and the CMA-tap-coefficient estimating unit.

### TECHNICAL FIELD

The present invention relates to a distortion compensating equalizer that compensates a distortion in a reception signal without using a publicly-known system. In particular, the present invention relates to a distortion compensating equalizer in which a Constant Modulus Algorithm (CMA) is used.

### BACKGROUND ART

In the following section, a conventional equalizer will be explained. For example, a reception signal waveform includes a waveform that is temporally delayed because of the multipath transmission or the individual wave sources. In other words, the characteristic that the combined signal at the reception point has a constant envelope is lost, and there is a distortion. It is possible to compensate such a distortion by using an adaptive equalizer.

Generally speaking, an adaptive equalizer uses an adaptive filter and a tap coefficient estimating device. The adaptive filter is called a transversal filter or a moving average filter and includes a chain of delay elements. Provided at the output of each of the delay elements is a multiplier that multiplies the output of the delay element by a tap coefficient. Further, all the outputs from the multipliers are added together, and the result of the addition is used as the output of the adaptive filter. The tap coefficient estimating device has an evaluation function that is a squared average error between the adaptive filter output and the corresponding reference signal and performs an update so as to make the evaluation function minimum. The reference signal is a signal for judging a known signal sequence or a signal after being output from the adaptive filter.

A blind equalization has a tap coefficient estimating device that corrects distortions without using a known sequence signal. In this case, an evaluation function that is different from the squared average error mentioned above is used. An example of estimation algorithms for tap coefficients used in a conventional blind equalizer is the CMA.

The CMA is especially effective, for example, when a temporal delay is caused in a transmission signal that has a constant envelope and on which frequency modulation or phase modulation has been applied, because of the multipath transmission or the individual wave sources, and thus the characteristic that the combined signal at the reception point has a constant envelope is lost, and the waveform has a distortion (See Non-patent Document 1).

In the following section, the operation in an example where a conventional blind equalizer receives, for example, a frequency modulation (FM) signal disclosed in the Non-patent Document 1 mentioned below, will be explained. It should be noted that an FM transmission signal that has no distortion is a signal having a waveform with a constant envelope in which one of the amplitude and the electric power is equally distributed on the positive side and the negative side.

For example, in the conventional blind equalizer, the analogue/digital (A/D) converter performs an analog/digital conversion on the received FM signal, and the result of the conversion is input to a digital filter.

The digital filter is a transversal filter or a moving average filter and includes a chain of delay elements. Provided at the output of each of the delay elements is a multiplier that multiplies the output of the delay element by a tap coefficient. Further, all the outputs from the multipliers are added together, and the result of the addition is used as the output of the digital filter. For example, the output of the digital filter is output to a CMA tap coefficient estimating device and to an FM demodulating unit.

The CMA tap coefficient estimating device receives the output signal from the A/D converter and the output signal from the digital filter, estimates a tap coefficient using the CMA, and updates the tap coefficient. A tap coefficient value, which is the output from the CMA tap coefficient estimating device, is input to the digital filter and is used as the tap coefficient for the multipliers. The output from the digital filter in which the tap coefficient that has been estimated by the CMA tap coefficient estimating device is used has a waveform in which distortions have been compensated.

The FM demodulating unit receives the output signal from the digital filter and performs FM demodulation on the FM reception signal in which the distortions have been compensated. Thus, it is possible to obtain an FM demodulated signal that has a high level of precision.

Non-patent Document 1: J. R. Treichler and B. G. Agee, “A New Approach to Multipath Correction of Constant Modulus Signals”, IEEE Trans., vol. ASSP-31, No2, pp. 459-472, 1983

### DISCLOSURE OF INVENTION

Problem to be Solved by the Invention

Conventional blind equalizers that use a CMA are widely used in mobile communication with wireless signal processing; however, the equalizing process requires that a transmission signal be a transmission signal having a constant envelope and polarity on which frequency modulation or phase modulation has been applied (i.e. The transmission signal has a waveform in which the amplitude is equally distributed on the positive side and the negative side.). On the other hand, in an optical communication system using an optical fiber, Non Return to Zero (NRZ) signals and Return to Zero (RZ) signals are mainly used. When an optical signal is converted to an electric signal on the reception side, the wave is detected using a photo diode (PD); therefore, the signals are characterized with single polarity. Thus, a problem arises where, for the blind equalizer using a CMA, the requirement for the equalization process is not fulfilled in the optical communication system using an optical fiber.

In an optical fiber cable for a super high-speed optical communication system, a relatively large Polarization Mode Dispersion (PMD) occurs. Thus, a problem arises where the PMD puts a limit to the transfer speed or the transfer distance. The PMD is a phenomenon where there is a difference in the transmission speed in the orthogonal polarization mode of the optical signal transferred in the optical fiber and where there is a temporal delay in the waveform. Accordingly, the waveform at the reception point has a shape in which the main wave and other various delay waves are combined, and the signal is one of an NRZ signal and an RZ signal each having a distortion.

In view of the situations described above, the present invention aims to provide a distortion compensating equalizer (i.e. a blind equalizer) in which a CMA is used and that is able to compensate distortions in the NRZ signal and the RZ signal.

Means for Solving Problem

To solve the above problems and to achieve the object, a distortion compensating equalizer according to one aspect of the present invention employs a constant modulus algorithm (CMA). The distortion compensating equalizer includes a reception-signal adjusting unit that adjusts a waveform of a digital reception signal in such a manner that an amplitude of the digital reception signal is equally distributed on a positive side and a negative side; and an equalizing unit including a digital filter unit that adds a predetermined delay to an input signal sequentially by delay elements serially connected as many as taps, multiplies a delay-added signal output from each of the delay elements by a corresponding tap coefficient, adds all signals after the multiplication, and outputs a result of the addition, and a CMA-tap-coefficient estimating unit that performs an estimation of a tap coefficient using the CMA, based on an output signal from the digital filter unit and an output signal from the reception-signal adjusting unit. The equalizing unit compensates a distortion in the waveform of the adjusted reception signal by repeating processes of the digital filter unit and the CMA-tap-coefficient estimating unit.

According to the present invention, the adjustment processing is performed so that the amplitude components of the reception signal are equally distributed on the positive side and the negative side, and the equalizing processing is performed on the reception signal on which the adjustment processing has been performed.

Effect of the Invention

According to the present invention, the adjustment processing is performed so that the amplitude components of the reception signal are equally distributed on the positive side and the negative side, and the equalizing processing is performed on the reception signal on which the adjustment processing has been performed. Thus, an effect is achieved where it is possible to compensate distortions, for example, in an NRZ signal or an RZ signal, in a reception signal characterized with single polarity, or in a reception signal in which the amplitude is not equally distributed on the positive side and the negative side.

### BRIEF DESCRIPTION OF DRAWINGS

FIG. 1 is a drawing of the configuration of a distortion compensating equalizer according to a first embodiment of the present invention;

FIG. 2 is a drawing of an example of an NRZ signal before and after a reference value processing;

FIG. 3 is a drawing of an example of the configuration of the digital filter unit;

FIG. 4 is a drawing of the configuration of a distortion compensating equalizer according to a second embodiment of the present invention;

FIG. 5 is a drawing of the configuration of a distortion compensating equalizer according to a third embodiment of the present invention;

FIG. 6 is a drawing of the configuration of a distortion compensating equalizer according to a fourth embodiment of the present invention;

FIG. 7 is a drawing of the configuration of a distortion compensating equalizer according to a fifth embodiment of the present invention;

FIG. 8 is a drawing of the configuration of a distortion compensating equalizer according to a sixth embodiment of the present invention;

FIG. 9 is a drawing of the configuration of a distortion compensating equalizer according to a seventh embodiment of the present invention;

FIG. 10 is a drawing of the configuration of a distortion compensating equalizer according to a eighth embodiment of the present invention;

FIG. 11 is a drawing of an example of the configuration of the judgment-reference-value calculating unit;

FIG. 12 is a drawing of the configuration of a distortion compensating equalizer according to a ninth embodiment of the present invention;

FIG. 13 is a drawing of the configuration of a distortion compensating equalizer according to a tenth embodiment of the present invention;

FIG. 14 is a drawing of an example of the configuration of the post-judgment digital filter unit; and

FIG. 15 is a drawing of the configuration of a distortion compensating equalizer according to a eleventh embodiment of the present invention;

### EXPLANATIONS OF LETTERS OR NUMERALS

1 A/D CONVERTING UNIT
2, 2d REFERENCE-VALUE CALCULATING UNIT
3 REFERENCE-VALUE PROCESSING UNIT
4 DIGITAL FILTER UNIT
5, 5a, 5c, 5d, 5e, 5g CMA-TAP-COEFFICIENT ESTIMATING UNIT
6, 6e, 6f, 6g JUDGING UNIT
11, 11b NEAR-ZERO-POINT DETECTING UNIT
12 NEAR-ZERO-POINT AVOIDING UNIT
21, 21c TIMING ADJUSTING UNIT
31 ERROR-THRESHOLD-VALUE JUDGING UNIT
41 ANALOG-REFERENCE-VALUE PROCESSING UNIT
42 D/A CONVERTING UNIT
43 ANALOG FILTER UNIT
51 ANALOG-REFERENCE-VALUE PROCESSING UNIT
61, 61g JUDGMENT-REFERENCE-VALUE CALCULATING UNIT
62, 62g CONVERGENCE-THRESHOLD-VALUE JUDGING UNIT
63 THRESHOLD-VALUE CONVERTING UNIT
71 POST-JUDGMENT DIGITAL FILTER UNIT
72 DELAY ADJUSTING UNIT
73 DISTORTION ELIMINATING UNIT
81 POST-JUDGMENT ANALOG FILTER UNIT
82 DELAY ADJUSTING UNIT
83 DISTORTION ELIMINATING UNIT
84 D/A CONVERTING UNIT
101-1, 101-2, 101-(N−1) DELAY ELEMENT
102-0, 102-1, 102-2, 102-(N−1) MULTIPLIER
103 ADDER
201 SIGNAL BRANCHING UNIT
202, 203 STATISTIC-VALUE CALCULATING UNIT
204 THRESHOLD-VALUE CALCULATING UNIT
205 THRESHOLD-VALUE SETTING UNIT
301-0, 301-1, 301-2, 301-(NN−1) DELAY ELEMENT
302-0, 302-1, 302-2, 302-(NN−1) MULTIPLIER
303 ADDER

### BEST MODE(S) FOR CARRYING OUT THE INVENTION

Exemplary embodiments of a distortion compensating equalizer according to the present invention will be explained in detail below with reference to the accompanying drawings. It should be noted that the present invention is not limited to these embodiments.

### First Embodiment

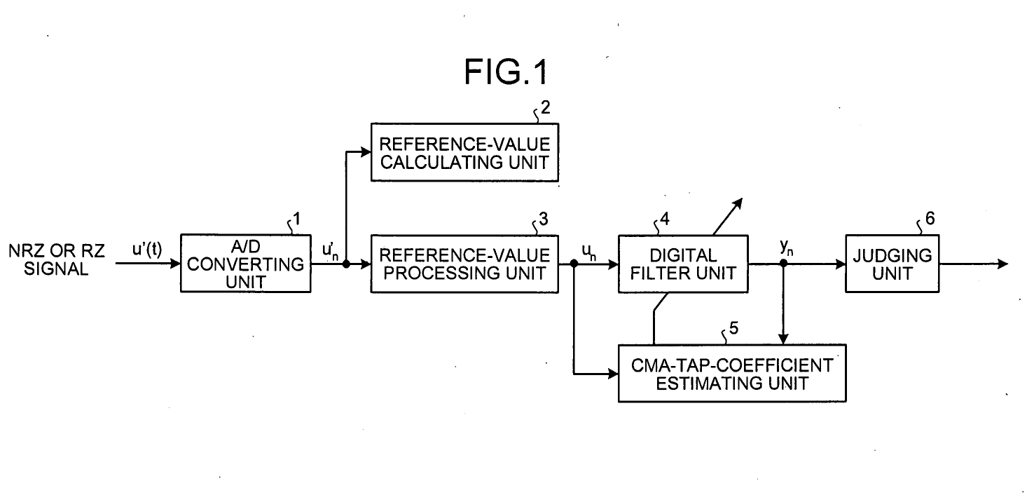

FIG. 1 is a drawing of the configuration of a distortion compensating equalizer according to a first embodiment of the present invention. The distortion compensating equalizer includes an A/D converting unit 1, a reference-value calculating unit 2, a reference-value processing unit 3, a digital filter unit 4, and a CMA-tap-coefficient estimating unit 5, and a judging unit 6. In the first embodiment, the processing in which an NRZ signal is used will be explained for the sake of convenience of explanation; however, the present invention is not limited to this example. It is possible to apply the invention to an RZ signal in the same manner as well.

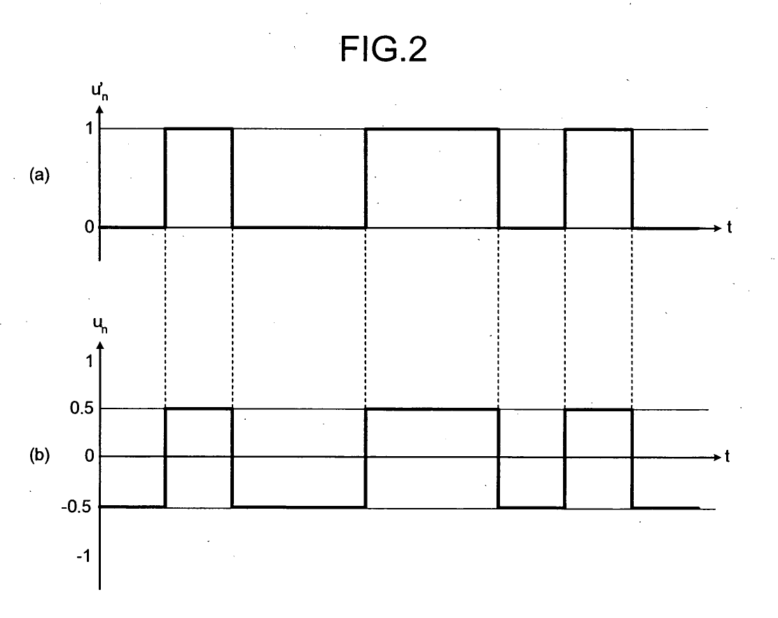

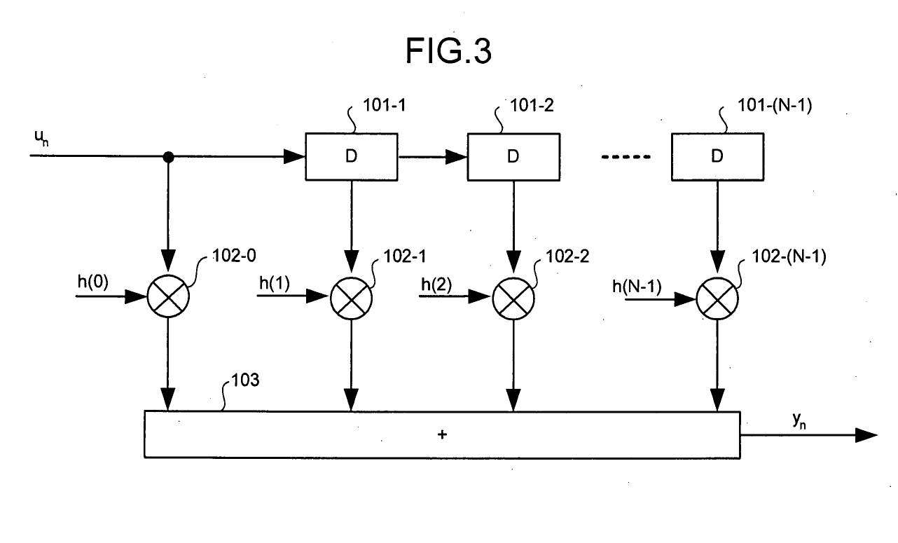

The operation of the distortion compensating equalizer according to the first embodiment configured as described above will be explained. FIG. 2 is a drawing of an NRZ signal before and after a reference value processing. To be more specific, in (a), the NRZ signal U′ₙ that is output by the A/D converting unit 1 and has no distortion is shown. In (b), the output signal uₙ from the reference-value processing unit 3 is shown. FIG. 3 is a drawing of an example of the configuration of the digital filter unit 4. The digital filter unit 4 includes the delay elements (D) 101-1, 101-2, . . . 101-(N−1), the multipliers 102-0, 102-1, 102-2, . . . 102-(N−1) each of which multiplies the output of a different one of the delay elements by a corresponding tap coefficient, and the adder 103 that adds the outputs from the multipliers together.

As shown in FIG. 1, the A/D converting unit 1 converts an analog electric signal (an analog NRZ signal) into a digital electric signal. For example, the A/D converting unit 1 samples the analog NRZ signal u′(t), which is a positive input signal, at a speed that allows as many as 1/T′ signals to be sampled per second, when the transmission data bitrate is 1/T. The A/D converting unit 1 then outputs, as the output signal, an NRZ signal u′(nT′) to the reference-value calculating unit 2 and the reference-value processing unit 3. In the description above, “t” denotes a time, “T” denotes the transmission data period, “T′” denotes the sampling period of the A/D converting unit 1, and “n” denotes an integer value. When L=T/T′0 is satisfied, L is a positive integer. Hereinafter, “nT′” will be simply written as “n” {u′ₙ=u′(nT′)}.

Next, the reference-value calculating unit 2 calculates a reference value a, based on the output signal u′ₙ from the A/D converting unit 1. In the present example, the average value of u′ₙs in a number of samples in the past is calculated as the reference value a, for example.

On the other hand, the reference-value processing unit 3 adjusts the output signal u′ₙ from the A/D converting unit 1 (i.e. adjusts the digital value [the amplitude value] that corresponds to the voltage of the analog signal), based on the reference value a and generates, for example, a waveform in which the amplitude value is equally distributed on the positive side and the negative side, as shown in FIG. 2(b). As an example, the reference-value processing unit 3 subtracts the reference value a from the output signal u′ₙ from the A/D converting unit 1, as shown in Equation (1) and outputs the result of the subtraction to the digital filter unit 4 and the CMA-tap-coefficient estimating unit 5, as a signal uₙ in which the amplitude is equally distributed on the positive side and the negative side.
uₙ=u′ₙ−α (1)

Next, in the digital filter unit 4, each of the delay elements (corresponding to 101-N to 101-(N−1)), of which there are as many as N−1, adds a delay to the input signal uₙ and respectively outputs a signal to which the delay has been added, where the number of taps is N and the tap coefficients output from the CMA-tap-coefficient estimating unit 5, which is described later, are h(0) to h(N−1). The delay amount of each of the delay elements is specified so as to be one of the bit periods T, T/2, and T/L. Subsequently, each of the multipliers (corresponding to 102-0 to 102-(N−1)) multiplies a different one of the output signals from the delay elements by a corresponding one of the tap coefficients (corresponding to h(0) to h(N−1)). The adder 103 then adds the signals obtained as the results of the multiplications by the multipliers together and outputs the result of the addition to the CMA-tap-coefficient estimating unit 5 and the judging unit 6, as a waveform yₙ in which the distortions have been compensated.

When the processing performed by the digital filter unit 4 is expressed using a general equation (vector representation: “→”), firstly, the input signal u′ₙ to the digital filter unit 4 and the tap coefficient h(k) (where k=0, 1, 2, . . . N−1), which is the output signal from the CMA-tap-coefficient estimating unit 5, can be expressed using Equation (2).

$$\begin{matrix}[ Equation 1 ] & \\ {{u}^{->}}_{n} = ( \begin{matrix}u [ n ] \\ u [ n - 1 ] \\ ⋮ \\ u [ n - ( N - 1 ) ]\end{matrix} ) {{h}^{->}}_{n} = ( \begin{matrix}h [ 0 ] \\ h [ 1 ] \\ ⋮ \\ h [ N - 1 ]\end{matrix} ) & ( 2 )\end{matrix}$$

The output signal yₙ from the digital filter unit 4 can be expressed using Equation (3).

[Equation 2]
yₙ=\vec{h}ₙ^{T}\vec{u}ₙ (3)

In the equation above, the superscript T denotes a vector transposition, whereas the subscript n denotes the period nT′.

Subsequently, the CMA-tap-coefficient estimating unit 5 operates with the bit period T. Then, the tap coefficient is updated from hₘ (real number vector representation) to hₘ₊₁, based on the output signal uₙ from the reference-value processing unit 3 and the output signal yₙ. The suffix m denotes the sampling time when the bit period is T. When the input sequence to the N multipliers (corresponding to 102-0 to 102-(N−1)) that are included in the digital filter unit 4 at a bit period time is expressed as uₘ (a real number vector), while the output signal is expressed as yₘ, the evaluation function Q for the Constant Modulus Algorithm (CMA) can be expressed as in Equation (4). Because L=T/T′ (where L is a positive integer) is satisfied as mentioned above, the sampling time n when the sampling period is T′ and the sampling time m when the bit period is T satisfy m=nL.

$$\begin{matrix}[ Equation 3 ] & \\ Q = E [ {\vert {\vert {y}_{m} \vert}^{p} - {R}^{p} \vert}^{q} ] & ( 4 )\end{matrix}$$

In Equation (4), R is a constant that expresses the value of an ideal envelop of the transmission signal. R^{P} may be a constant obtained as a result of a calculation using Equation (5) with a transmission signal sₙ that has no distortion. E[−] denotes an expectation value.

$$\begin{matrix}[ Equation 4 ] & \\ {R}^{p} = \frac{E [ {\vert {s}_{n} \vert}^{2 p} ]}{E [ {\vert {s}_{n} \vert}^{p} ]} & ( 5 )\end{matrix}$$

For example, for the NRZ signal uₙ that is shown in FIG. 2(b) (which has no distortion), because the waveform has the amplitude of ±0.5 on either side of zero (when a=0.5), the constant R is specified so as to satisfy R=0.5.

On the basis of Equations (3) and (4), the CMA-tap-coefficient estimating unit 5 updates the tap coefficient hₘ (real number vector representation) so that the evaluation function Q becomes minimum and outputs the tap coefficient hₘ₊₁ (real number vector representation) that has been obtained as a result of the update to the digital filter unit 4. Equation.(6) is an estimate/update expression for the tap coefficient using the CMA, based on the input sequence uₘ (a real number vector) and the output signal yₘ of the N multipliers (corresponding to 102-0 to 102-(N−1)) that are included in the digital filter unit 4 at the bit period time.

[Equation 5]
\vec{h}ₘ+1=\vec{h}ₘ−μ∇ₕQ (6)

The CMA-tap-coefficient estimating unit 5 assigns Equation (3) to Equation (4) while letting p, q be 1 or 2 and calculates the gradient.

$$\begin{matrix}[ Equation 6 ] & \\ {∇}_{h} Q = {y}_{ m} {\vert {y}_{m} \vert}^{- 1} {{u}^{->}}_{m} * sgn ( \vert {y}_{ m} \vert - R ) & ( 7 ) \\ [ Equation 7 ] & \\ {∇}_{h} Q = 2 {y}_{ m} { {u}^{->}}_{m} * sgn ( {\vert {y}_{ m} \vert}^{2} - {R}^{ 2} ) & ( 8 ) \\ [ Equation 8 ] & \\ {∇}_{h} Q = 2 {y}_{ m} {\vert {y}_{m} \vert}^{- 1} {{u}^{->}}_{m} * ( \vert {y}_{ m} \vert - R ) & ( 9 ) \\ [ Equation 9 ] & \\ {∇}_{h} Q = 4 {y}_{ m} {{u}^{->}}_{m} * ( {\vert {y}_{ m} \vert}^{2} - {R}^{2} ) & ( 10 )\end{matrix}$$

In the Non-patent Document 1, the variable that corresponds to uₘ* (complex vector representation) is the complex conjugate of uₘ (complex vector representation); however, as for the NRZ signal shown in FIG. 2, only the real number components are dealt with so that uₘ (real number vector representation) that is the output signal from the reference-value processing unit 3 is used. In the equations above, “sgn” denotes the signum of a real variable and is defined as in Equation (11). Alternatively, it is acceptable to define “sgn” as in Equation (11)′, using R mentioned above in Equation (4).

$$\begin{matrix} & \\ [ Equation 10 \text{-} 1 ] & \\ sgn ( z ) = \{ \begin{matrix}1 ( z > 0 ) \\ 0 ( z = 0 ) \\ - 1 ( z < 0 )\end{matrix} \\ & ( 11 ) \\ [ Equation 10 \text{-} 2 ] & \\ sgn ( z ) = \{ \begin{matrix}R ( z > 0 ) \\ 0 ( z = 0 ) \\ - R ( z < 0 )\end{matrix} & ( {11}^{′} )\end{matrix}$$

In Equation (6), μ is a parameter for adjusting the updating speed of the tap coefficients and is set to an appropriate value. The CMA-tap-coefficient estimating unit 5 calculates the tap coefficient hₘ₊₁ (real number vector representation) that allows the evaluation function Q in the Equation (4) to be minimum, by applying the Equations (7), (8), (9) and (10) to the Equation (6). It should be noted, however, that the initial value of the tap coefficient hₘ (real number vector representation) should be set to an appropriate value so as to avoid the situation expressed in the Equation (12) below. For example, Δ is set to an appropriate value (for example, Δ=1.0) as shown in Equation (13).

$$\begin{matrix}[ Equation 11 ] \\ & \\ {{h}^{->}}_{m} = ( \begin{matrix}h [ 0 ] = 0 \\ h [ 1 ] = 0 \\ ⋮ \\ h [ N - 1 ] = 0\end{matrix} ) \\ & ( 12 ) \\ [ Equation 12 ] & \\ {{{h}^{->}}^{} }_{m} = ( \begin{matrix}h [ 0 ] = Δ \\ h [ 1 ] = 0 \\ ⋮ \\ h [ N - 1 ] = 0\end{matrix} ) & ( 13 )\end{matrix}$$

Subsequently, the digital filter unit 4 performs the calculation in the Equation (3) above, using hₘ₊₁ (real number vector representation) that has been updated with the bit period and the signal uₙ₊₁ (real number vector representation) that is newly input and outputs the result of the calculation to the judging unit 6, as an output signal yₙ₊₁. In the first embodiment, the distortions in the waveform are compensated by causing the digital filter unit 4 and the CMA-tap-coefficient estimating unit 5 to perform their respective processing repeatedly.

At last, the judging unit 6 performs a judgment processing on the waveform in which the distortions have been corrected through the processing described above.

As explained so far, according to the first embodiment, the adjustment processing is performed so that the amplitude components of the reception signal are equally distributed on the positive side and the negative side, and the equalizing processing is performed on the reception signal on which the adjustment processing has been performed. With this arrangement, it is possible to obtain a distortion compensating equalizer in which the CMA is used and that is able to compensate distortions in the NRZ signal or the RZ signal.

In the description of the first embodiment, the example in which the distortions in the NRZ signal or the RZ signal are compensated is explained; however, the present invention is not limited to this example. It is possible to compensate, in the same manner, distortions in a signal that is characterized with single polarity, as long as the signal is a signal having a constant envelope. Further, it is possible to compensate, in the same manner, distortions in a reception signal of which the amplitude is not equally distributed on the positive side and the negative side, as long as the signal is a signal having a constant envelope.

### Second Embodiment

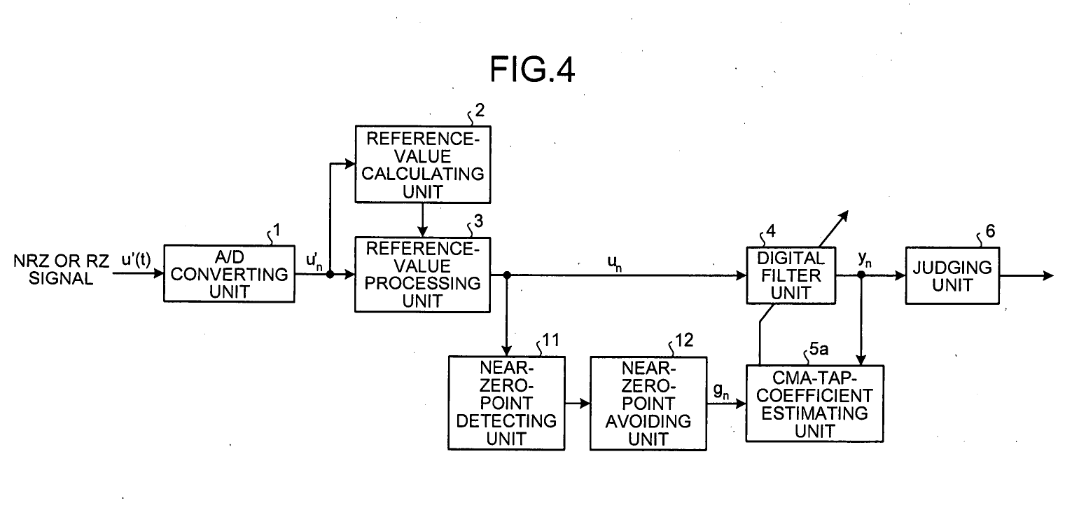

FIG. 4 is a drawing of the configuration of a distortion compensating equalizer according to a second embodiment of the present invention. The distortion compensating equalizer includes the A/D converting unit 1, the reference-value calculating unit 2, the reference-value processing unit 3, the digital filter unit 4, a CMA-tap-coefficient estimating unit 5a, the judging unit 6, a near-zero-point detecting unit 11, and a near-zero-point avoiding unit 12. Some of the constituent elements that are the same as the ones in the first embodiment will be referred to using the same reference characters, and the explanation thereof will be omitted. In the following section, only the processing that is different from the processing in the first embodiment will be explained.

Firstly, the reference-value processing unit 3 outputs the output signal uₙ, which is explained earlier, to the near-point detecting unit 11 and the digital filter unit 4.

The near-zero-point detecting unit 11 specifies a specific threshold value e in advance. When the absolute value of the output signal uₙ from the reference-value processing unit 3 becomes smaller than e, the near-zero-point detecting unit 11 detects the signal. The near-zero-point avoiding unit 12 corrects the detected signal so that the signal is one of d and −d and outputs the corrected signal to the CMA-tap coefficient estimating unit 5a. Each of d and −d is a value of which the absolute value is equal to or larger than e. Any signal that has not been detected by the near-zero-point detecting unit 11 is output, while being maintained as the current signal, by the near-zero-point avoiding unit 12 to the CMA-tap-coefficient estimating unit 5a. The output from the near-zero-point avoiding unit 12 is expressed as gₙ, and the vector representation thereof is defined as shown in Equation (14).

$$\begin{matrix}[ Equation 13 ] & \\ {{g}^{->}}_{n} = ( \begin{matrix}g [ n ] \\ g [ n - 1 ] \\ ⋮ \\ g [ n - ( N - 1 ) ]\end{matrix} ) & ( 14 )\end{matrix}$$

Normally, when the reception signal on which the sample processing has been performed by the A/D converting unit 1 has a near-zero point frequently, the estimation of the tap coefficient cannot be performed correctly. However, the processing performed by the near-zero-point detecting unit 11 and the near-zero-point avoiding unit 12 makes it possible to avoid near-zero point data.

The CMA-tap-coefficient estimating unit 5a performs the processing expressed in Equations (6), and (7) to (10), based on the output signal yₘ from the digital filter unit 4 with the bit period and the corrected signal gₘ and estimates the tap coefficient. In this situation, uₘ* (complex vector representation) in Equations (7) to (10) is replaced with the corrected signal gₘ (real number vector representation), and an updating processing is performed.

As explained so far, according to the second embodiment, the portion of the output signal uₙ from the reference-value processing unit that has an absolute value being equal to or smaller than the specified threshold value is detected, and the detected signal is corrected so as to have a value equal to or larger than the threshold value. With this arrangement, it is possible to achieve the same effects as in the first embodiment and also to estimate the tap coefficient correctly even if the reception signal on which the A/D converting unit has performed the sample processing has a near-zero point frequently.

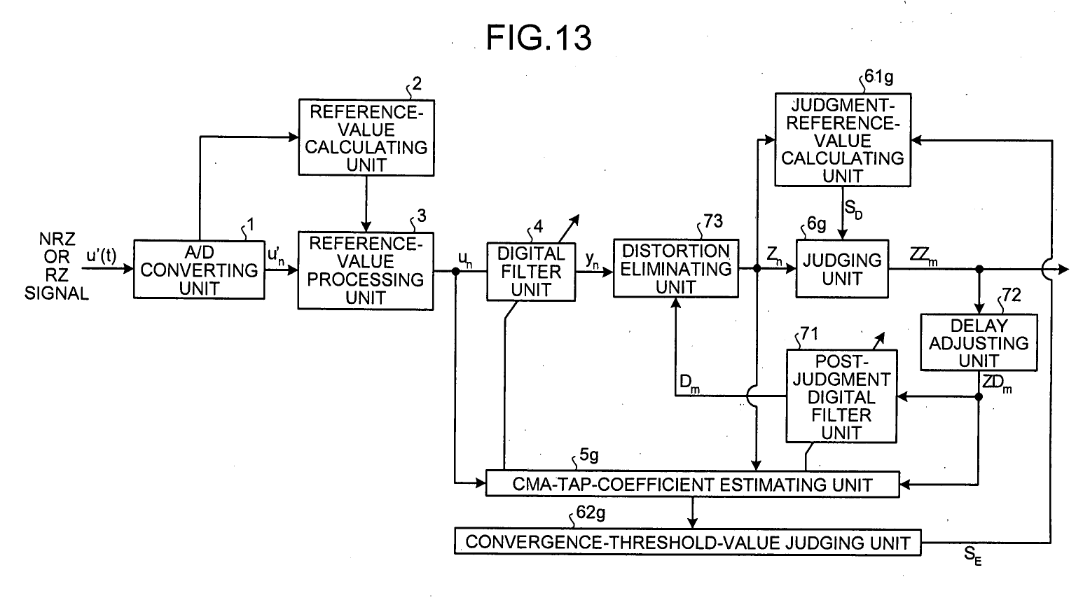

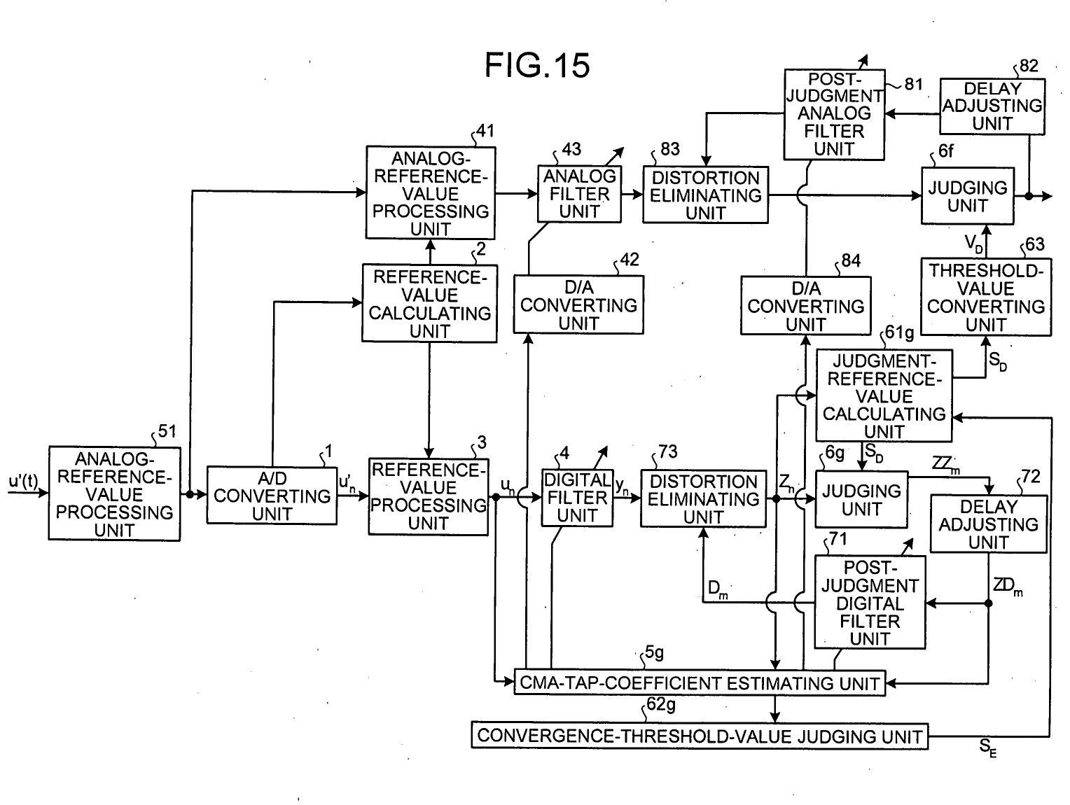

In the second embodiment, the near-zero-point detecting unit 11 and the near-zero-point avoiding unit 12 are applied to the configuration shown in FIG. 1 according to the first embodiment; however, the present invention is not limited to this example. It is possible to achieve the same effects even when these units are applied to the configuration shown in FIG. 13 according to the tenth embodiment or the configuration shown in FIG. 15 according to the eleventh embodiment.

### Third Embodiment

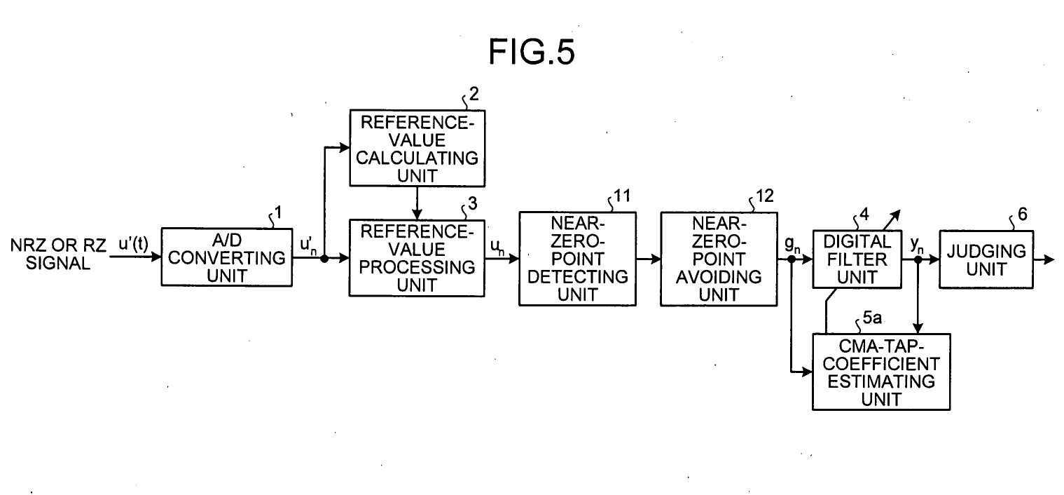

FIG. 5 is a drawing of the configuration of a distortion compensating equalizer according to a third embodiment of the present invention. The distortion compensating equalizer includes the A/D converting unit 1, the reference-value calculating unit 2, the reference-value processing unit 3, the digital filter unit 4, the CMA-tap-coefficient estimating unit 5a, the judging unit 6, the near-zero-point detecting unit 11, and the near-zero-point avoiding unit 12. Some of the constituent elements that are the same as the ones in the first embodiment or the second embodiment will be referred to using the same reference characters, and the explanation thereof will be omitted. In the following section, only the processing that is different from the processing in the first embodiment or the second embodiment will be explained.

Firstly, the near-zero-point avoiding unit 12 outputs the corrected signal to the digital filter unit 4 and the CMA-tap-coefficient estimating unit 5a. Any signal that has not been detected by the near-zero-point detecting unit 11 is output, while being maintained as the current signal, to the digital filter unit 4 and the CMA-tap-coefficient estimating unit 5a.

The digital filter unit 4 performs the calculation in Equation (3), based on the output signal from the near-zero-point avoiding unit 12 and the tap coefficient output by the CMA-tap-coefficient estimating unit 5a and outputs the signal yₙ, which is the result of the calculation, to the CMA-tap-coefficient estimating unit 5a and the judging unit 6.

As explained so far, according to the third embodiment, through the processing that is the same as the one according to the second embodiment, the portion of the output signal uₙ that has an absolute value being equal to or smaller than the specified threshold value is detected, and the detected signal is corrected so as to have a value equal to or larger than the threshold value. Further, the corrected signal is output to the digital filter unit and the CMA-tap-coefficient estimating unit. With this arrangement, it is possible to achieve the same effects as in the first embodiment and also to estimate the tap coefficient with an even higher level of precision than in the second embodiment.

In the third embodiment, the near-zero-point detecting unit 11 and the near-zero-point avoiding unit 12 are applied to the configuration shown in FIG. 1 according to the first embodiment; however, the present invention is not limited to this example. It is possible to achieve the same effects even when these units are applied to the configuration shown in FIG. 13 according to the tenth embodiment or the configuration shown in FIG. 15 according to the eleventh embodiment.

### Fourth Embodiment

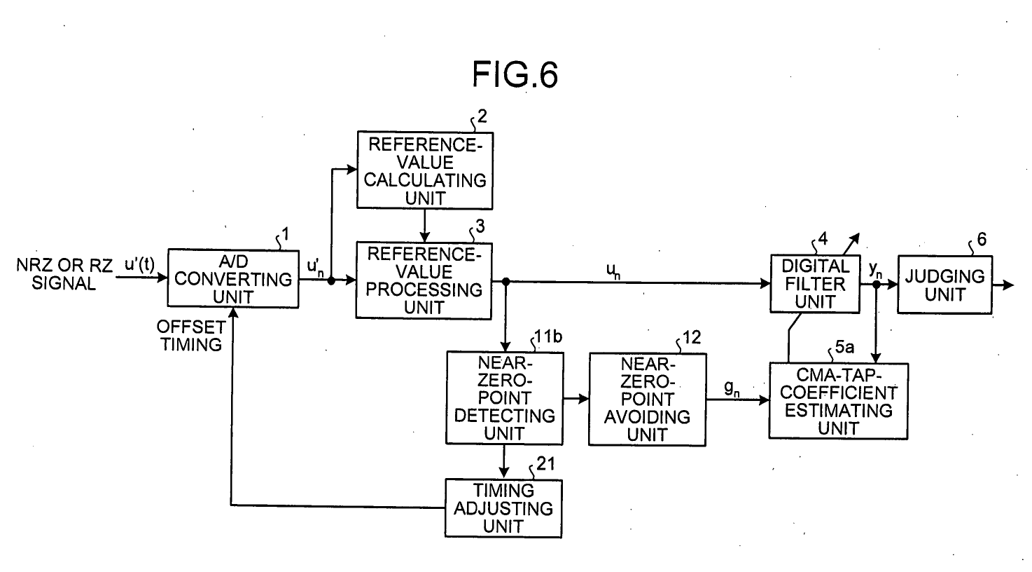

FIG. 6 is a drawing of the configuration of a distortion compensating equalizer according to a fourth embodiment of the present invention. The distortion compensating equalizer includes the A/D converting unit 1, the reference-value calculating unit 2, the reference-value processing unit 3, the digital filter unit 4, the CMA-tap-coefficient estimating unit 5a, the judging unit 6, a near-zero-point detecting unit 11b, the near-zero-point avoiding unit 12, and a timing adjusting unit 21. Some of the constituent elements that are the same as the ones in the first embodiment, the second embodiment, or the third embodiment will be referred to using the same reference characters, and the explanation thereof will be omitted. In the following section, only the processing that is different from the processing in the first embodiment, the second embodiment, or the third embodiment will be explained.

As explained earlier, the near-zero-point detecting unit 11b outputs the result-of the near-zero point detection to the near-zero-point avoiding unit 12. Further, the near-zero-point detecting unit 11b outputs a signal (a detection signal) that indicates that the near-zero point has been detected to the timing adjusting unit 21.

When the near-zero-point detecting unit 11b frequently detects a near-zero point detection signal, the timing adjusting unit 21 offsets the sampling timing of the reception signal for the A/D converting unit 1. With this arrangement, no near-zero point signals are sampled.

Next, an example of the operation performed by the timing adjusting unit 21 will be explained specifically. For example, a counter is provided inside the timing adjusting unit 21, and a threshold value β is set as a specific counter value. The counter counts up the detection number when the near-zero point is detected a number of times in a row. The counter value is reset to zero when no near-zero point is detected. Consequently, when the counter value exceeds the threshold value β, the timing adjusting unit 21 outputs a signal for offsetting the timing by as much as t samples to the A/D converting unit 1. The sampling time T′ will not be changed. Alternatively, it is also acceptable to change the condition for counting up or the threshold value β, depending on the magnitude of distortions.

As explained so far, according to the fourth embodiment, when the detection signal for the near-zero point is frequently detected, no near-zero point signals are sampled. With this arrangement, it is possible to achieve the same effects as in the first embodiment and also to estimate the tap coefficient correctly because there is no near-zero point in the reception signal on which the A/D converting unit has performed the sample processing.

In the fourth embodiment, the timing adjusting unit 21 is applied to the configuration shown in FIG. 4 according to the second embodiment; however, the present invention is not limited to this example. It is possible to achieve the same effects even when the timing adjusting unit 21 is applied to the configuration shown in FIG. 5 according to the third embodiment, the configuration shown in FIG. 13 according to the tenth embodiment, or the configuration shown in FIG. 15 according to the eleventh embodiment.

### Fifth Embodiment

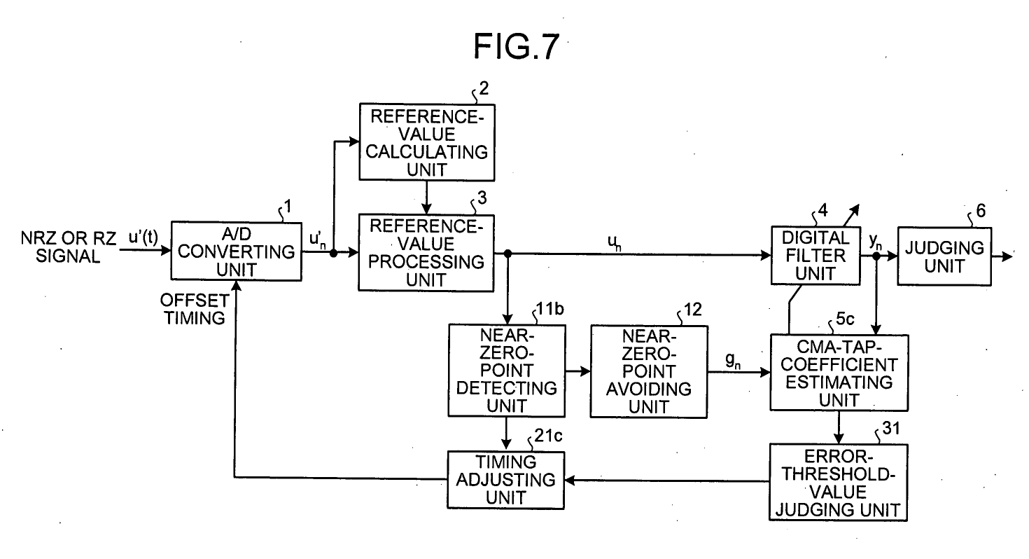

FIG. 7 is a drawing of the configuration of a distortion compensating equalizer according to a fifth embodiment of the present invention. The distortion compensating equalizer includes the A/D converting unit 1, the reference-value calculating unit 2, the reference-value processing unit 3, the digital filter unit 4, a CMA-tap-coefficient estimating unit 5c, the judging unit 6, the near-zero-point detecting unit 11b, the near-zero-point avoiding unit 12, a timing adjusting unit 21c, and an error-threshold-value judging unit 31. Some of the constituent elements that are the same as the ones in any of the first through the fourth embodiments will be referred to using the same reference characters, and the explanation thereof will be omitted. In the following section, only the processing that is different from the processing in the first through the fourth embodiments will be explained.

The CMA-tap-coefficient estimating unit 5c estimates the tap coefficient through the same processing as the one performed by the CMA-tap-coefficient estimating unit 5a explained above. Further, the CMA-tap-coefficient estimating unit 5c outputs the value of |yₘ|^{P}−R^{P} of the evaluation function Q shown in Equation (4) to the error-threshold-value judging unit 31.

The error-threshold-value judging unit 31 specifies a predetermined threshold value γ in advance and compares the threshold value γ with the value of |yₘ|^{P}−R^{P} The error-threshold-value judging unit 31 then outputs the comparison result (a signal indicating which is larger/smaller) to the timing adjusting unit 21c.

The timing adjusting unit 21c adjusts the sampling timing, based on the detection signal output from the near-zero-point detecting unit 11b and the comparison result (the signal indicating larger/smaller) output from the error-threshold-value judging unit 31. As an example, when the signal output from the error-threshold-value judging unit 31 is ζ, if ζ is “1”, it is judged that |yₘ|^{P}−R^{P} is larger than the threshold value γ. If ζ is “0”, it is judged that |yₘ|^{P}−R^{P} is smaller than the threshold value γ.

The operation performed by the timing adjusting unit 21c will be explained specifically. For example, a counter is provided inside the timing adjusting unit 21c, and a threshold value β is set as a specific counter value. The counter counts up the detection number when the near-zero point is detected a number of times in a row. The counter value is reset to zero when no near-zero point is detected. Consequently, when the counter value exceeds the threshold value β, the timing adjusting unit 21c refers to ζ. If ζ is “1”, the timing adjusting unit 21c outputs a signal for offsetting the timing by as much as t samples to the A/D converting unit 1. The sampling time T′ will not be changed. On the other hand, when the counter value exceeds the threshold value β, the timing adjusting unit 21c refers to ζ, and if ζ is “0”, the timing adjusting unit 21c outputs no timing offset signal. Alternatively, it is also acceptable to change the condition for counting up or the threshold value β, depending on the magnitude of distortions.

As explained so far, according to the fifth embodiment, the sampling timing is adjusted, based on the detection signal for the near-zero point that is output from the near-zero-point detecting unit and the result of the comparison between the threshold value γ and |yₘ|^{P}−R^{P} that is output from the error-threshold-value judging unit. With this arrangement, it is possible to achieve the same effects as in the fourth embodiment explained above and also to find such sampling timing for the A/D converting unit that makes the value of |yₘ|^{P}−R^{P} converge to zero.

In the fifth embodiment, the timing adjusting unit 21c and the error-threshold-value judging unit 31 are applied to the configuration shown in FIG. 4 according to the second embodiment; however, the present invention is not limited to this example. It is possible to achieve the same effects even when these units are applied to the configuration shown in FIG. 5 according to the third embodiment, the configuration shown in FIG. 13 according to the tenth embodiment, or the configuration shown in FIG. 15 according to the eleventh embodiment.

### Sixth Embodiment

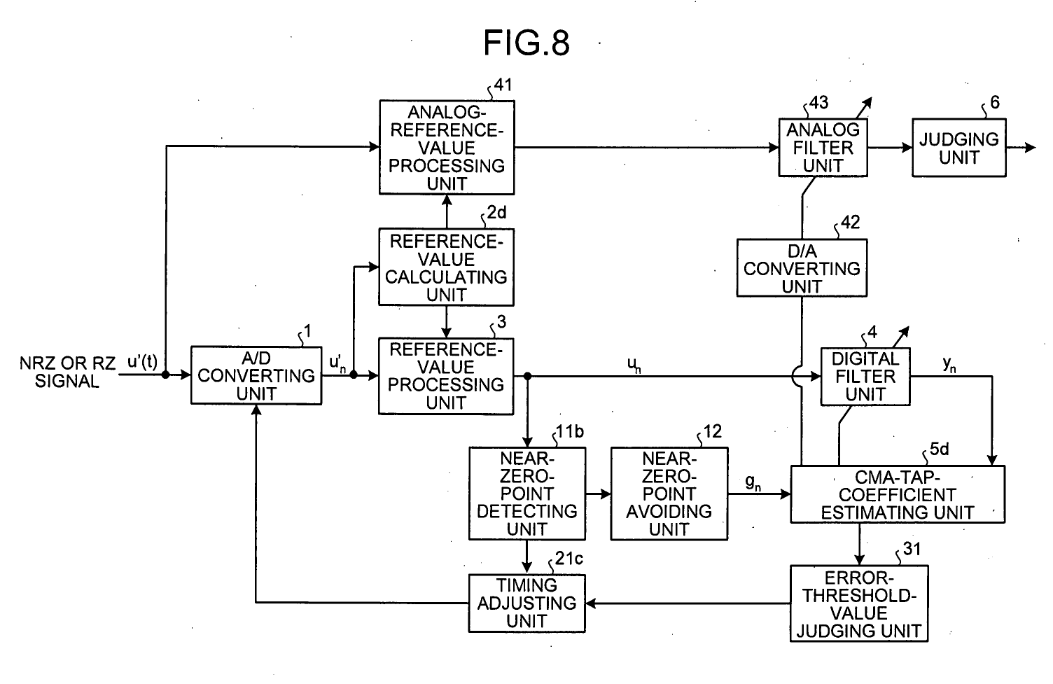

FIG. 8 is a drawing of the configuration of a distortion compensating equalizer according to a sixth embodiment of the present invention. The distortion compensating equalizer includes the A/D converting unit 1, a reference-value calculating unit 2d, the reference-value processing unit 3, the digital filter unit 4, a CMA-tap-coefficient estimating unit 5d, the judging unit 6, the near-zero-point detecting unit 11b, the near-zero-point avoiding unit 12, the timing adjusting unit 21c, the error-threshold-value judging unit 31, an analog-reference-value processing unit 41, a D/A converting unit 42, and an analog filter unit 43. Some of the constituent elements that are the same as the ones in any of the first through the fifth embodiments will be referred to using the same reference characters, and the explanation thereof will be omitted. In the following section, only the processing that is different from the processing in the first through the fifth embodiments will be explained.

Firstly, in the same manner as explained earlier, the analog NRZ signal or the analog RZ signal u′(t) that has been received is input to the A/D converting unit 1. According to the sixth embodiment, the analog NRZ signal or the analog RZ signal u′(t) is also input to the analog reverence value processing unit 41. The reference-value calculating unit 2d outputs a reference value a that has been calculated through the same processing as the one performed by the reference-value calculating unit 2, to the reference-value processing unit 3 and the analog-reference-value processing unit 41.

The analog-reference-value processing unit 41 adjusts the analog NRZ signal or the analog RZ signal u′(t), based on the reference value calculated by the reference-value calculating unit 2d and generates a waveform in which the amplitude value is equally distributed on the positive side and the negative side. As an example, the analog-reference-value processing unit 41 converts the reference value a to an analog voltage signal and performs the processing of, for example, biasing the analog NRZ signal or the analog RZ signal that has been received, based on the voltage value.

The CMA-tap-coefficient estimating unit 5d estimates the tap coefficient through the same processing as the one performed by the CMA-tap-coefficient estimating unit 5c explained above. Further, the CMA-tap-coefficient estimating unit 5d outputs the value of |yₘ|^{P}−R^{P} of the evaluation function Q shown in Equation (4) to the error-threshold-value judging unit 31. In addition, the CMA-tap-coefficient estimating unit 5d outputs the tap coefficient (the digital signal with the sampling time T′) to the D/A converting unit 42.

The D/A converting unit 42 converts the digital signal with the sampling time T′ to an analog signal and outputs the analog signal to the analog filter unit 43. The sampling timing for the D/A converting unit 42 may be, for example, the same as the one for the A/D converting unit 1.

The analog filter unit 43 realizes the same processing as the one performed by the digital filter unit 4, not through a digital processing but through an analog processing. In this situation, each of all the delay elements, the multipliers, and the adder that are shown in FIG. 3 is configured with an analog element. Further, the delay amount of each of the delay elements is equal to the delay amount of each of the delay elements included in the digital filter. The delay amount is specified so as to be one of the bit periods T, T/2, and T/L.

At last, the judging unit 6 performs a judgment processing on the waveform in which the distortions have been corrected through the processing described above.

As explained so far, according to the sixth embodiment, the adjustment processing is performed so that the amplitude components of the analog reception signal are equally distributed on the positive side and the negative side. Then, the equalizing processing is performed on the analog reception signal on which the adjustment processing has been performed. With this arrangement, it is possible to obtain a blind adaptive equalizer in which a CMA is used and that is able to compensate distortions in the analog NRZ signal or the analog RZ signal.

In the sixth embodiment, the timing adjusting unit 21c, the error-threshold-value judging unit 31, the analog-reference-value processing unit 41, the D/A converting unit 42, and the analog filter unit 43 are applied to the configuration shown in FIG. 4 according to the second embodiment; however, the present invention is not limited to this example. It is possible to achieve the same effects when these units are applied to the configuration shown in FIG. 5 according to the third embodiment.

### Seventh Embodiment

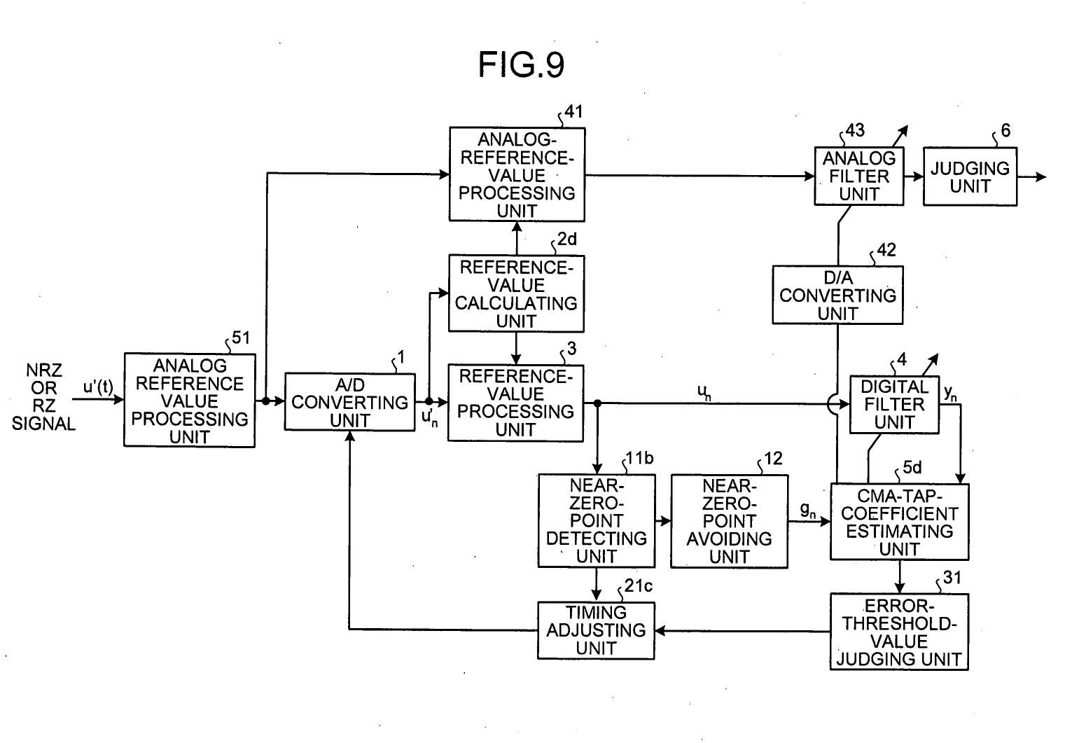

FIG. 9 is a drawing of the configuration of a distortion compensating equalizer according to a seventh embodiment of the present invention. The distortion compensating equalizer includes the A/D converting unit 1, the reference-value calculating unit 2d, the reference-value processing unit 3, the digital filter unit 4, the CMA-tap-coefficient estimating unit 5d, the judging unit 6, the near-zero-point detecting unit 11b, the near-zero-point avoiding unit 12, the timing adjusting unit 21c, the error-threshold-value judging unit 31, the analog-reference-value processing unit 41, the D/A converting unit 42, the analog filter unit 43, and an analog-reference-value processing unit 51. Some of the constituent elements that are the same as the ones in any of the first through the sixth embodiments will be referred to using the same reference characters, and the explanation thereof will be omitted. In the following section, only the processing that is different from the processing in the first through the sixth embodiments will be explained.

According to the seventh embodiment, an analog NRZ signal or an analog RZ signal that has been received is input to the analog-reference-value processing unit 1. Through an analog electric signal processing, the analog-reference-value processing unit 51 roughly adjusts the waveform so that the voltage of the reception signal is, to some extent, equally distributed on the positive side and the negative side (for example, so that the analog reception signal characterized with single polarity will have bipolarity). The analog-reference-value processing unit 51 then outputs the adjusted reception signal to the A/D converting unit 1 and the analog-reference-value processing unit 41.

As explained so far, according to the seventh embodiment, the analog-reference-value processing unit 51 makes rough adjustments in advance so that the voltage of the reception signal is, to some extent, equally distributed on the positive side and the negative side. Thus, for example, when the reference value a is calculated from the average value of the outputs from the A/D converting unit 1, it is possible to reduce the number of samples used for calculating the average value. Consequently, it is possible to calculate the reference value a at a high speed. Further, it is also possible to make the convergence (estimation) speed at which the tap coefficient is estimated using the CMA higher. In other words, it is possible to compensate the distortions in the analog waveform at a higher speed than according to the sixth embodiment.

In the seventh embodiment, the timing adjusting unit 21c, the error-threshold-value judging unit 31, the analog-reference-value processing unit 41, the D/A converting unit 42, the analog filter unit 43, and the analog-reference-value processing unit 51 are applied to the configuration shown in FIG. 4 according to the second embodiment; however, the present invention is not limited to this example. It is possible to achieve the same effects even when these units are applied to the configuration shown in FIG. 5 according to the third embodiment.

### Eighth Embodiment

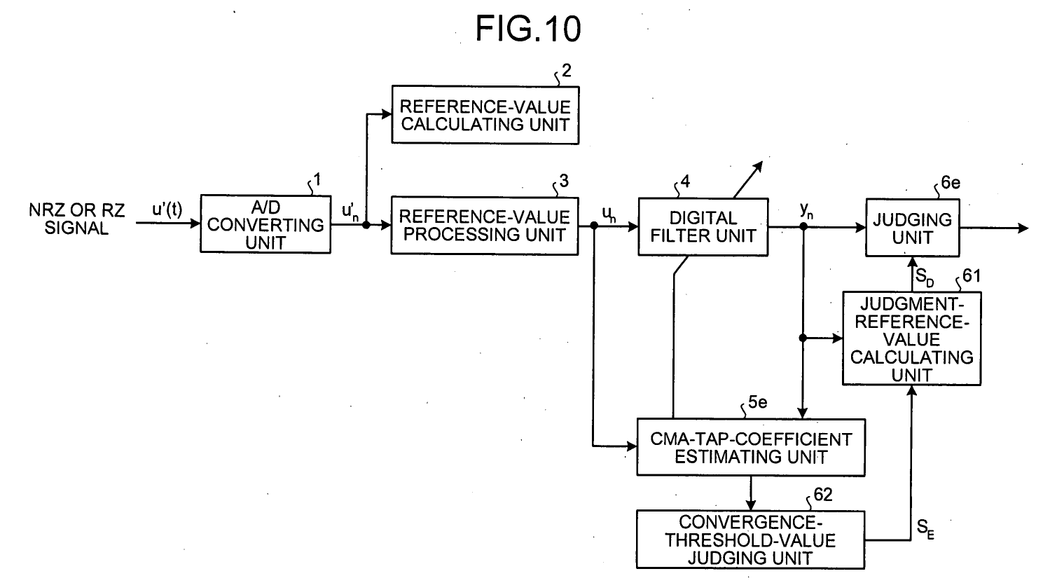

FIG. 10 is a drawing of the configuration of a distortion compensating equalizer according to an eighth embodiment of the present invention. The distortion compensating equalizer includes the A/D converting unit 1, the reference-value calculating unit 2, the reference-value processing unit 3, the digital filter unit 4, a CMA-tap-coefficient estimating unit 5e, a judging unit 6e, a judgment-reference-value calculating unit 61, and a convergence-threshold-value judging unit 62. Some of the constituent elements that are the same as the ones in the first embodiment will be referred to using the same reference characters, and the explanation thereof will be omitted. In the following section, only the processing that is different from the processing in the first embodiment will be explained.

The CMA-tap-coefficient estimating unit 5e estimates the tap coefficient through the same processing as the one performed by the CMA-tap-coefficient estimating unit 5 according to the first embodiment explained above. Further, the CMA-tap-coefficient estimating unit 5e outputs the value of |yₘ|^{P}−R^{P} of the evaluation function Q shown in Equation (4) to the convergence-threshold-value judging unit 62.

The digital filter unit 4 outputs the output signal yₙ explained above to the CMA-tap-coefficient estimating unit 5e, the judging unit 6e, and the judgment-reference-value calculating unit 61.

The convergence-threshold-value judging unit 62 operates with the bit period T, specifies a predetermined threshold value η in advance, and averages the value of |yₘ|^{P}−R^{P} for a predetermined interval CL. The convergence-threshold-value judging unit 62 then compares the threshold value η with the calculated average value, to see which is larger and outputs the result of the comparison, namely S_{E}, to the judgment-reference-value calculating unit 61. For example, when the average value is smaller than η, S_{E}=1 is satisfied. When the average value is larger than η, S_{E}=0 is satisfied.

The judgment-reference-value calculating unit 61 operates with the bit period T and calculates an optimal judgment threshold value S_{D}, based on statistic values such as the signal distribution, the signal dispersion, and the average value of the output signal yₙ from the digital filter unit 4, through a processing described later. The judgment-reference-value calculating unit 61 then outputs the calculation result to the judging unit 6e.

The judgment-reference-value calculating unit 61 also determines an operation reference based on S_{E}, which is the output value from the convergence-threshold-value judging unit 62. For example, when S_{E}=0 is satisfied, no operation is performed, and S_{D}=0 is output to the judging unit 6e. On the other hand, when S_{E}=1 is satisfied, the operation is started, and the calculated optimal judgment threshold value, namely S_{D}, is output to the judging unit 6e.

The judging unit 6e operates with the bit period T and uses S_{D}, which is the output signal from the judgment-reference-value calculating unit 61, as a threshold value for the binary judgment. The judging unit 6e judges the output signal yₙ from the digital filter unit 4, based on the threshold value. In the binary judgment in which the threshold value S_{D} is used as the reference, when the output signal yₙ from the digital filter unit 4 is larger than the threshold value S_{D}, the output signal yₙ is judged to be 1 or R. When the output signal yₙ is smaller than the threshold value S_{D}, the output signal yₙ is judged to be 0 (or −1) or −R.

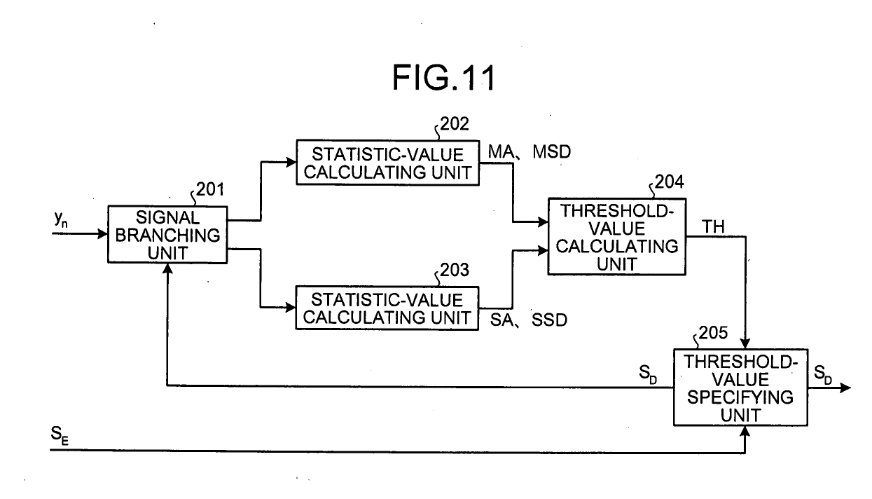

An example of the operation performed by the judgment-reference-value calculating unit 61 will be explained specifically, with reference to the drawing. FIG. 11 is a drawing of the configuration of the judgment-reference-value calculating unit 61. The judgment-reference-value calculating unit 61 includes a signal branching unit 201, statistic-value calculating units 202 and 203, a threshold-value calculating unit 204, and a threshold-value setting unit 205.

Firstly, the threshold-value setting unit 205 refers to S_{E} once in every predetermined CL period. When S_{E}=1 is satisfied, the threshold-value setting unit 205 outputs an operation signal to the signal branching unit 201, the statistic-value calculating unit 202, the statistic-value calculating unit 203, and the threshold-value calculating unit 204 so that they operate only for the predetermined period CL. The threshold-value setting unit 205 then specifies the output value, namely TH, which is the result of the calculation performed by the threshold-value calculating unit 204 described later, as the judgment threshold value S_{D} and outputs the judgment threshold-value S_{D}.

On the other hand, when S_{E}=0 is satisfied, the threshold-value setting unit 205 outputs a signal to the signal branching unit 201, the statistic-value calculating unit 202, the statistic-value calculating unit 203, and the threshold-value calculating unit 204 so that they do not operate. Subsequently, the threshold-value setting unit 205 specifies S_{D}=0 as the output value from the judgment-reference-value calculating unit 61. The initial value of S_{D} is set so as to satisfy S_{D}=0. In other words, when the threshold-value setting unit 205 detects S_{E}=1 for the first time, the threshold-value setting unit 205 outputs the operation signal to the signal branching unit 201, the statistic-value calculating unit 202, the statistic-value calculating unit 203, and the threshold-value calculating unit 204 so that they operate for the predetermined period. CL and outputs S_{D}=0 to the signal branching unit 201.

The signal branching unit 201 branches the output value yₙ from the digital filter unit 4, using the output value S_{D} from the threshold-value setting unit 205 as the threshold value. For example, when the output value yₙ from the digital filter unit 4 is larger than the threshold value S_{D}, the signal branching unit 201 outputs yₙ to the statistic-value calculating unit 202. Conversely, when the output value yₙ from the digital filter unit 4 is smaller than the threshold value S_{D}, the signal branching unit 201 outputs yₙ to the statistic-value calculating unit 203.

The statistic-value calculating unit 202 calculates, for example, the average value MA and the standard deviation value MSD, based on yₙ that is input during the predetermined period CL. On the other hand, the statistic-value calculating unit 203 calculates, for example, the average value SA and the standard deviation value SSD.

The threshold-value calculating unit 204 calculates a threshold value as shown in Equation (15), based on the average value MA, the standard deviation value MSD, the average value SA, and the standard deviation value SSD that have been calculated by the statistic-value calculating units 202 and 203. The threshold-value calculating unit 204 then outputs the result of the calculation in Equation (15), namely TH, to the threshold-value setting unit 205.

$$\begin{matrix}[ Equation 14 ] & \\ TH = \frac{ \frac{MA}{ MSD} + \frac{SA}{ SSD}}{ \frac{1}{ MSD} + \frac{1}{ SSD}} & ( 15 )\end{matrix}$$

As explained so far, the judgment-reference-value calculating unit 61 refers to the output signal S_{E} from the convergence-threshold-value judging unit 62 once in every predetermined CL period. When the tap coefficient is estimated by the CMA-tap-coefficient estimating unit 5e with a high level of precision and is converged, the judgment-reference-value calculating unit 61 keeps outputting S_{E}=1 once in every predetermined CL period. Thus, the optimal threshold value is constantly updated once in every CL period. On the other hand, when the tap coefficient is not estimated by the CMA-tap-coefficient estimating unit 5e with a high level of precision, S_{B}=0 is satisfied. Thus, the judgment reference calculating unit 61 outputs S_{D}=0 without calculating any threshold value. In this situation, the judging unit 6e performs the judgment processing based on the polarity (positive or negative).

As explained so far, according to the eighth embodiment, the judgment-reference-value calculating unit 61 calculates the optimal judgment threshold value. Also, the convergence-threshold-value judging unit 62 is provided so that the optimal threshold value is updated by adaptively exercising control on the signal in which distortions have been inhibited. With this arrangement, because the judging unit 6e is able to make judgment using the optimal threshold value, it is possible to inhibit judgment errors.

In the eighth embodiment, the CMA-tap-coefficient estimating unit 5e, the judging unit 6e, the judgment-reference-value calculating unit 61, and the convergence-threshold-value judging unit 62 are applied to the configuration shown in FIG. 1 according to the first embodiment; however, the present invention is not limited to this example. It is possible to achieve the same effects even when these units are applied to the configuration shown in FIG. 4 according to the second embodiment, the configuration shown in FIG. 5 according to the third embodiment, the configuration shown in FIG. 6 according to the fourth embodiment, or the configuration shown in FIG. 7 according to the fifth embodiment.

### Ninth Embodiment

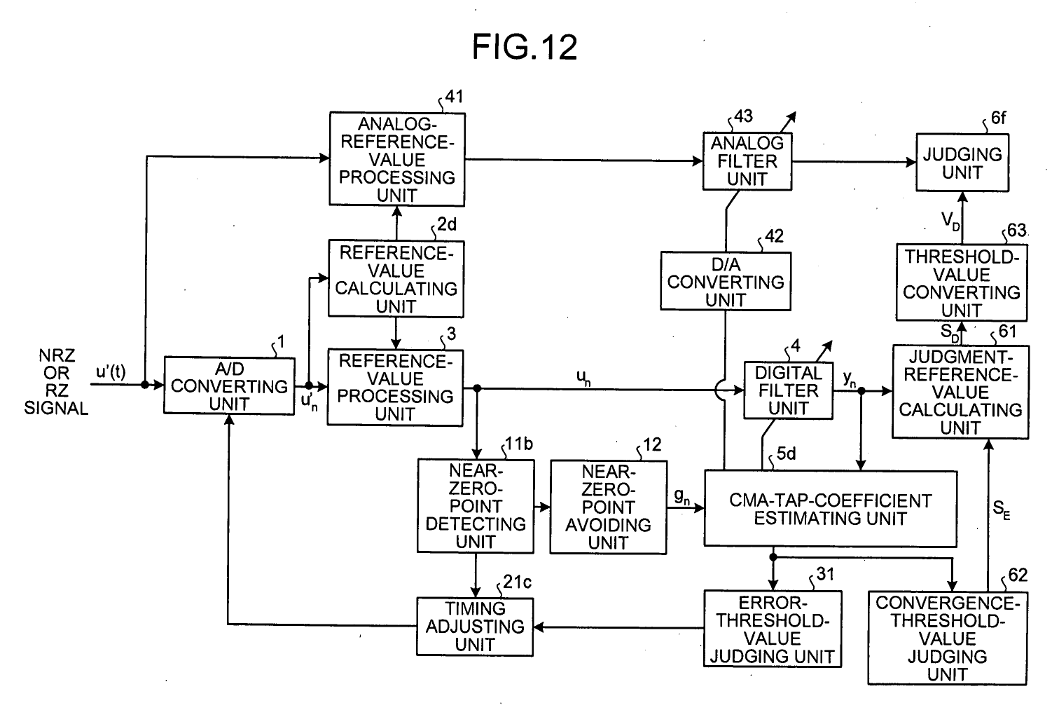

FIG. 12 is a drawing of the configuration of a distortion compensating equalizer according to a ninth embodiment of the present invention. The distortion compensating equalizer includes the A/D converting unit 1, the reference-value calculating unit 2d, the reference-value processing unit 3, the digital filter unit 4, the CMA-tap-coefficient estimating unit 5d, a judging unit 6f, the near-zero-point detecting unit 11b, the near-zero-point avoiding unit 12, the timing adjusting unit 21c, the error-threshold-value judging unit 31, the analog-reference-value processing unit 41, the D/A converting unit 42, the analog filter unit 43, the judgment-reference-value calculating unit 61, the convergence-threshold-value judging unit 62, and a threshold-value converting unit 63. Some of the constituent elements that are the same as the ones in the sixth embodiment or the eighth embodiment will be referred to using the same reference characters, and the explanation thereof will be omitted. In the following section, only the processing that is different from the processing in the sixth embodiment or the eighth embodiment will be explained.

The threshold-value converting unit 63 converts the optimal threshold value S_{D} that has been calculated by the judgment-reference-value calculating unit 61 into a voltage V_{D}, which is an analog value, and outputs V_{D} to the judging unit 6f.

The judging unit 6f judges, through an analog processing, the analog output signal from the analog filter unit 43 by performing the same processing as the one performed by the judging unit 6e according to the eighth embodiment. In this situation, the judging unit 6f is configured with an analog element and makes binary judgment, using the analog voltage threshold value VD output by the threshold-value converting unit 63 as the reference value.

As explained so far, according to the ninth embodiment, the method of calculating the optimal threshold value according to the eighth embodiment is applied to the method of compensating distortions in the analog NRZ signal or the analog RZ signal as described in the sixth embodiment. With this arrangement, it is possible to inhibit judgment errors for the analog NRZ signal or the analog RZ signal.

According to the ninth embodiment, the judgment-reference-value calculating unit 61 and the convergence-threshold-value judging unit 62, the threshold-value converting unit 63, and the judging unit 6f are applied to the configuration shown in FIG. 8 according to the sixth embodiment; however, the present invention is not limited to this example. It is possible to achieve the same effects even when these units are applied to the configuration shown in FIG. 9 according to the seventh embodiment.

### Tenth Embodiment

FIG. 13 is a drawing of the configuration of a distortion compensating equalizer according to a tenth embodiment of the present invention. The distortion compensating equalizer includes the A/D converting unit 1, the reference-value calculating unit 2, the reference-value processing unit 3, the digital filter unit 4, a CMA-tap-coefficient estimating unit 5g, a judging unit 6g, a judgment-reference-value calculating unit 61g, a convergence-threshold-value judging unit 62g, a post-judgment digital filter unit 71, a delay adjusting unit 72, and a distortion eliminating unit 73. Some of the constituent elements that are the same as the ones in the first embodiment will be referred to using the same reference characters, and the explanation thereof will be omitted. In the following section, only the processing that is different from the processing in the first embodiment will be explained.

Firstly, the output signal yₙ from the digital filter unit 4 is output to the distortion eliminating unit 73. The distortion eliminating unit 73 performs the processing expressed in Equation (16), based on the output signal Dₘ from the post-judgment digital filter unit 71, which is described later. Then, the output signal Zₙ from the distortion eliminating unit 73 is output to the judgment-reference-value calculating unit 61g, the judging unit 6g, and the CMA-tap-coefficient estimating unit 5g. Like in the first embodiment, the suffix m denotes the signal during the bit period time.

[Equation 15]
Zₙ=yₙ−Dₘ (16)

The judging unit 6g operates with the bit period T and performs the judgment processing on the output signal Zₙ from the distortion eliminating unit 73 based on the polarity (when S_{D}=0) or performs the judgment processing, using the threshold value control according to the eighth embodiment, based on the output signal S_{D} from the judgment-reference-value calculating unit 61g. Using the threshold value S_{D} as the reference, when the output signal Zₙ from the distortion eliminating unit 73 is larger than the threshold value S_{D}, the judging unit 6g judges the output signal Zₙ to be 1 or R. When the output signal Zₙ is smaller than the threshold value S_{D}, the judging unit 6g judges the output signal Zₙ to be −1 or −R. The output signal ZZₘ from the judging unit 6g is the final output from the distortion compensating equalizer and is also output to the delay adjusting unit 72.

The delay adjusting unit 72 adds a delay to the output signal ZZₘ from the judging unit 6g, using a delay element. The amount of delay of the delay element is adjusted so as to be T/2, for example, with the circuit delay of the judging unit 6g being included. The output signal ZDₘ from the delay adjusting unit 72 is output to the post-judgment digital filter unit 71 and the CMA-tap-coefficient estimating unit 5g.

The convergence-threshold-value judging unit 62g operates with the bit period T, specifies a predetermined threshold value q in advance, and averages the value of |Zₘ|_{P}−R^{P}, which is the output value from the CMA-tap-coefficient estimating unit 5g that is described later, for the predetermined period CL. Then, the convergence-threshold-value judging unit 62g compares the threshold value η with the average value to see which is larger. For example, when the average value is smaller than η, the convergence-threshold-value judging unit 62g outputs S_{E}=1. When the average value is larger than η, the convergence-threshold-value judging unit 62g outputs S_{E}=0.

The judgment-reference-value calculating unit 61g determines an operation reference based on S_{E}, which is the output value from the convergence-threshold-value judging unit 62g. For example, when S_{E}=0 is satisfied, no operation is performed, and 0 (S_{D}=0) is output to the judging unit 6g. On the other hand, when S_{E}=1 is satisfied, the operation is started, and the optimal judgment threshold value, namely S_{D}, is output to the judging unit 6g, using the method according to the eighth embodiment that is described above.

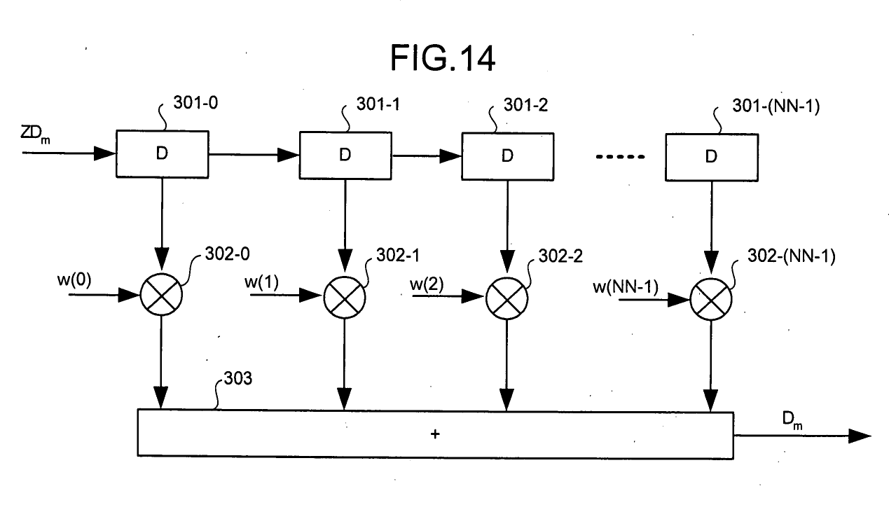

The post-judgment digital filter unit 71 operates with the bit period T and operates, for example, as shown in FIG. 14. FIG. 14 is a drawing of an example of the configuration of the post-judgment digital filter unit 71. For example, when the number of taps is NN, and the tap coefficients output from the CMA-tap-coefficient estimating unit 5g are w(0) to w(NN−1), in the post-judgment digital filter unit 71, each of the delay elements of which there are as many as NN (corresponding to 301-0 to 301-(NN−1)) adds a delay to the input signal ZDₘ, and each of the delay elements outputs a signal to which the delay has been added. The amount of delay of each of the delay elements is the bit period T. Subsequently, each of the multipliers (corresponding to 302-0 to 302-(NN−1)) multiplies a different one of the output signals from the delay elements by a corresponding one of the tap coefficients (corresponding to w(0) to w(NN−1)). The adder 303 then adds the signals that have been multiplied by the multipliers together and adds the result of the addition to the delay adjusting unit 72 as the waveform Dₘ in which distortions have been compensated.

When the processing performed by the post-judgment digital filter unit 71 is expressed using a general equation (vector representation: “→”), firstly, the input sequence ZDₘ₋₁ of the NN multipliers included in the post-judgment digital filter unit 71 and the tap coefficient w(k) (where k=0, 1, 2, . . . NN−1), which is the output signal from the CMA-tap-coefficient estimating unit 5g, can be expressed using Equation (17).

$$\begin{matrix}{}_{} & \\ [ Equation 16 ] & \\ {\vec{ZD}}_{m - 1} = ( \begin{matrix}ZD [ m - 1 ] \\ ZD [ m - 2 ] \\ ⋮ \\ ZD [ m - NN ]\end{matrix} ) { {w}^{->}}_{m} = ( \begin{matrix}w [ 0 ] \\ w [ 1 ] \\ ⋮ \\ w [ NN - 1 ]\end{matrix} ) & ( 17 )\end{matrix}$$

Then, the output signal Dₘ from the post-judgment digital filter unit 71 can be expressed using Equation (18).

[Equation 17]
Dₘ=\vec{w}ₘ^{T}ZDₘ₋₁ (18)

The CMA-tap-coefficient estimating unit 5g operates with the bit period T and calculates the tap coefficient hₘ (real number vector representation) for the digital filter unit 4 and the tap coefficient wₘ (real number vector representation) for the post-judgment digital filter unit 71, based on the output signal uₙ from the reference-value processing unit 3, the output signal Zₙ from the distortion eliminating unit 73, and the output signal ZDₘ from the delay adjusting unit 72. In this situation, yₘ in Equation (4) is replaced with Zₘ and, like in the first embodiment, the tap coefficients hₘ (real number vector representation) and wₘ (real number vector representation) are updated so that the evaluation function Q is minimized. Equations (19) are estimate/update expressions for the tap coefficients using the CMA, based on the output sequence uₘ (real number vector) of the N delay elements resulting from the input signal sequence of the digital filter unit 4 at a bit period time, the output signal Zₘ from the distortion eliminating unit 73, the input sequence ZDₘ₋₁ of the NN delay multipliers included in the post-judgment digital filter unit 71, and the output signal ZDₘ from the delay adjusting unit 72.

[Equation 18]
\vec{h}ₘ₊₁=\vec{h}ₘ−μ₁∇ₕQ
\vec{w}ₘ₊₁=\vec{w}ₘ−μ₂∇_{w}Q (19)

When yₘ in Equation (4) is replaced with Zₘ, while letting p, q in the evaluation function Q be 1 or 2, the second term on the right-hand side of the equation, namely ∇ₕQ and ∇_{w}Q, can be expressed as shown in Equations (20), (21), (22), and (23).

$$\begin{matrix}[ Equation 19 ] & \\ {∇}_{h} Q = {ZD}_{ m} {\vert {ZD}_{ m} \vert}^{- 1} {{u}^{->}}_{m} * sgn ( \vert {Z}_{ m} \vert - R ) \\ {∇}_{w} Q = {ZD}_{ m} {\vert {ZD}_{ m} \vert}^{- 1} {\vec{ZD}}_{m - 1} * sgn ( \vert {Z}_{ m} \vert - R ) & ( 20 ) \\ [ Equation 20 ] & \\ {∇}_{h} Q = 2 {ZD}_{ m} {{u}^{->}}_{m} * sgn ( {\vert {Z}_{ m} \vert}^{2} - {R}^{ 2} ) \\ {∇}_{w} Q = 2 {ZD}_{ m} {\vec{ZD}}_{m - 1} * sgn ( {\vert {Z}_{ m} \vert}^{2} - {R}^{ 2} ) & ( 21 ) \\ [ Equation 21 ] & \\ {∇}_{h} Q = 2 {ZD}_{ m} {\vert {ZD}_{ m} \vert}^{- 1} { {u}^{->}}_{m} * ( \vert {Z}_{ m} \vert - R ) \\ {∇}_{w} Q = 2 {ZD}_{ m} {\vert {ZD}_{ m} \vert}^{- 1} {\vec{ZD}}_{m - 1} * ( \vert {Z}_{ m} \vert - R ) & ( 22 ) \\ [ Equation 22 ] & \\ {∇}_{h} Q = 4 {ZD}_{ m} { {u}^{->}}_{m} * ( {\vert {Z}_{ m} \vert}^{2} - {R}^{ 2} ) & \end{matrix}$$

Like in the first embodiment, for u*ₘ (complex vector representation) and ZZ*ₘ (complex vector representation), uₘ (real number vector representation) and ZZₘ (real number vector representation) are used respectively. Each of μ₁ and μ₂ is a parameter for adjusting the updating speed of the tap coefficients and is set to an appropriate value. The initial value of the tap coefficient wₘ (real number vector representation) is set to 0 in all cases.

The CMA-tap-coefficient estimating unit 5g outputs |Zₘ|^{P}−R^{P} to the convergence-threshold-value judging unit 62g.

Subsequently, the distortions in the waveform are compensated by causing the digital filter unit 4, the distortion eliminating unit 73, the judging unit 6g, the delay adjusting unit 72, the post-judgment digital filter unit 71, and the CMA-tap-coefficient estimating unit 5g to perform their respective processing explained above repeatedly on the signal uₙ₊₁ (real number vector representation) that is newly input.

As explained so far, according to the tenth embodiment, in addition to the processing according to the first embodiment, distortions in the NRZ signal or the RZ signal are compensated, by using the post-judgment signal. With this arrangement, it is possible to compensate distortions in the signal that are too large to compensate with the method according to the first embodiment.

In the tenth embodiment, the CMA-tap-coefficient estimating unit 5g, the judging unit 6g, the post-judgment digital filter unit 71, the delay adjusting unit 72, and the distortion eliminating unit 73 are applied to the configuration shown in FIG. 1 according to the first embodiment; however, the present invention is not limited to this example. It is possible to achieve the same effects even when these units are applied to the configuration shown in FIG. 4 according to the second embodiment, the configuration shown in FIG. 5 according to the third embodiment, the configuration shown in FIG. 6 according to the fourth embodiment, or the configuration shown in FIG. 7 according to the fifth embodiment.

### Eleventh Embodiment

FIG. 15 is a drawing of the configuration of a distortion compensating equalizer according to an eleventh embodiment of the present invention. The distortion compensating equalizer includes the A/D converting unit 1, the reference-value calculating unit 2, the reference-value processing unit 3, the digital filter unit 4, the CMA-tap-coefficient estimating unit 5g, the judging unit 6g, the judging unit 6f, the analog-reference-value processing unit 41, the D/A converting unit 42, the analog filter unit 43, the analog-reference-value processing unit 51, the judgment-reference-value calculating unit 61g, the convergence-threshold-value judging unit 62g, the threshold-value converting unit 63, the post-judgment digital filter unit 71, the delay adjusting unit 72, the distortion eliminating unit 73, a post-judgment analog filter unit 81, a delay adjusting unit 82, a distortion eliminating unit 83, and a D/A converting unit 84. Some of the constituent elements that are the same as the ones in any of the sixth through the tenth embodiments will be referred to using the same reference characters, and the explanation thereof will be omitted. In the following section, only the processing that is different from the processing in the sixth through the tenth embodiment will be explained.

Like in the tenth embodiment, the CMA-tap-coefficient estimating unit 5g estimates the tap coefficients of the digital filter unit 4 and the post-judgment digital filter unit 71. Also, like in the seventh embodiment, the tap coefficient of the digital filter unit 4 is output to the D/A converting unit 42. Likewise, the tap coefficient of the post-judgment digital filter unit 71 that has been estimated by the CMA-tap-coefficient estimating unit 5g is output to the D/A converting unit 84. Subsequently, the D/A converting unit 84 converts the tap coefficient into an analog voltage signal so as to generate the tap coefficient of the post-judgment analog filter unit 81.

The delay adjusting unit 82 performs, through an analog processing, the same processing as, the one performed by the delay adjusting unit 72 according to the tenth embodiment, on the output signal from the judging unit 6f, which is described later. In this situation, each of the delay elements is configured with an analog element. The amount of delay is adjusted so as to be T/2, with the circuit delay of the judging unit 6f being taken into account.

The post-judgment analog filter unit 81 performs, through an analog processing, the same processing as the one performed by the post-judgment digital filter unit 71 according to the tenth embodiment, on the output signal from the judging unit 6f. In this situation, each of all the delay elements, the multipliers, and the adder that are shown in FIG. 14 is configured with an analog element. The delay amount of each of the delay elements is set to the bit period T, which is equal to the delay amount of each of the delay elements included in the digital filter.

The distortion eliminating unit 83 performs, through an analog processing, the same processing as the one performed by the distortion eliminating unit 73 according to the tenth embodiment, based on the output signal from the post-judgment analog filter unit 81 and the output signal from the analog filter unit 43. The subtraction circuit that realizes the calculation in Equation (16) is configured with an analog element.

The judging unit 6f performs the same processing as the one according to the ninth embodiment. The output value from the judging unit 6f is the final output value from the distortion compensating equalizer and is also output to the analog delay adjusting unit 82.

As explained so far, according to the eleventh embodiment, the method of compensating distortions according to the tenth embodiment is also applied to the analog NRZ signal and the analog RZ signal. In addition, like in the ninth embodiment, it is possible to inhibit judgment errors for the analog NRZ signal or the analog RZ signal.

### INDUSTRIAL APPLICABILITY

As described so far, the distortion compensating equalizer according to the present invention is useful as a blind adaptive equalizer that compensates distortions in the reception signal without using a publicly-known system. In particular, the distortion compensating equalizer according to the present invention is suitable as an equalizer in which a CMA is used.

1-13. (canceled)

14. A distortion compensating equalizer employing a constant modulus algorithm, the distortion compensating equalizer comprising:
a reception-signal adjusting unit that adjusts a waveform of a digital reception signal in such a manner that an amplitude of the digital reception signal is equally distributed on a positive side and a negative side; and
an equalizing unit including
a digital filter unit that adds a predetermined delay to an input signal sequentially by delay elements serially connected as many as taps, multiplies a delay-added signal output from each of the delay elements by a corresponding tap coefficient, adds all signals after the multiplication, and outputs a result of the addition; and
a CMA-tap-coefficient estimating unit that performs an estimation of a tap coefficient using the constant modulus algorithm, based on an output signal from the digital filter unit and an output signal from the reception-signal adjusting unit, wherein
the equalizing unit compensates a distortion in the waveform of the adjusted reception signal by repeating processes of the digital filter unit and the CMA-tap-coefficient estimating unit.

15. The distortion compensating equalizer according to claim 14, wherein
the reception-signal adjusting unit includes
a reference-value calculating unit that calculates a reference value for adjusting the waveform of the digital reception signal in such a manner that the amplitude of the digital reception signal is equally distributed on the positive side and the negative side; and
a reference-value processing unit that subtracts the reference value from the digital reception signal, and outputs a result of the subtraction as the adjusted reception signal.

16. The distortion compensating equalizer according to claim 14, further comprising:
a near-zero-point detecting unit that detects a portion of the adjusted reception signal having an absolute value smaller than a predetermined threshold value as a near-zero point; and
a near-zero-point correcting unit that corrects the detected near-zero point so that the absolute value of the adjusted reception signal becomes equal to or larger than the threshold value and outputs a corrected value, and outputs a signal point that is not detected by the near-zero-point detecting unit without a correction, wherein
the CMA-tap-coefficient estimating unit of the equalizing unit estimates the tap coefficient using the output signal from the digital filter unit and an output signal from the near-zero-point correcting unit.

17. The distortion compensating equalizer according to claim 16, wherein
the digital filter unit of the equalizing unit uses either one of the adjusted reception signal and the output signal from the near-zero-point correcting unit as the input signal.

18. The distortion compensating equalizer according to claim 16, further comprising:
an analog-to-digital converting unit that converts an analog reception signal into the digital reception signal; and
a timing adjusting unit that adjusts, when the near-zero point is detected a predetermined number of times in a row, sampling timing of the analog-to-digital converting unit so that the analog-to-digital converting unit does not sample signals at the detected near-zero points.

19. The distortion compensating equalizer according to claim 18, further comprising:
a judging unit that judges a magnitude of an error based on either one of an error between the output signal from the digital filter unit and an ideal envelope value and a mean squared error, which is an evaluation function of the constant modulus algorithm, obtained from the CMA-tap-coefficient estimating unit of the equalizing unit, wherein
when the near-zero point is detected a predetermined number of times in a row, the timing adjusting unit adjusts the sampling timing of the analog-to-digital converting unit based on a result of judging the magnitude of the error.

20. The distortion compensating equalizer according to claim 19, further comprising:
an analog-reception-signal adjusting unit that adjusts a waveform of the analog reception signal in such a manner that an amplitude of the analog reception signal is equally distributed on a positive side and a negative side;
a digital-to-analog converting unit that converts the tap coefficient, which is a digital value, estimated by the CMA-tap-coefficient estimating unit of the equalizing unit into an analog value; and
an analog filter unit that realizes a same process as a process performed by the digital filter unit of the equalizing unit through an analog processing, using the adjusted analog reception signal and the analog-value-converted tap coefficient, wherein
the distortion compensating equalizer compensates a waveform distortion of the adjusted analog reception signal by repeating processes of the equalizing unit, the digital-to-analog converting unit, and the analog filter unit.

21. The distortion compensating equalizer according to claim 20, wherein
the waveform of the analog reception signal having a characteristic of a single polarity is roughly adjusted to have bipolarity, and
the roughly-adjusted analog reception signal is used as an input to the analog-to-digital converting unit and the analog-reception-signal adjusting unit.

22. The distortion compensating equalizer according to claim 14, further comprising:
a tap-coefficient judging unit that judges a precision level of the estimation of the tap coefficient based on an evaluation function of the constant modulus algorithm for estimating the tap coefficient by the CMA-tap-coefficient estimating unit;
a judgment-reference-value calculating unit that calculates a judgment threshold value for the distortion-compensated signal based on a result of judging the precision level of the estimation of the tap coefficient; and
a distortion-compensated-signal judging unit that judges the distortion-compensated-signal based on the judgment threshold value.

23. The distortion compensating equalizer according to claim 22, wherein
the judgment-reference-value calculating unit includes
a threshold-value setting unit that sets the judgment threshold value as an output value based on the result of judging the precision level of the estimation of the tap coefficient;
a signal branching unit that branches the output signal from the digital filter unit into two based on the set output value;
a statistic-value calculating unit that calculates an average and a standard deviation in a predetermined interval for each of the branched signals; and
a threshold-value calculating unit that calculates the judgment threshold value specified by the threshold-value setting unit, based on the statistic values, wherein
processes of the signal branching unit, the statistic-value calculating unit, and the threshold-value calculating unit are performed repeatedly at regular intervals.

24. The distortion compensating equalizer according to claim 20, further comprising:
a tap-coefficient judging unit that judges a precision level of the estimation of the tap coefficient based on an evaluation function of the constant modulus algorithm for estimating the tap coefficient by the CMA-tap-coefficient estimating unit;
a judgment-reference-value calculating unit that calculates a judgment threshold value, which is a digital value, for the distortion-compensated signal that is the output signal of the digital filter unit based on a result of judging the precision level of the estimation of the tap coefficient;
a threshold-value converting unit that converts the judgment threshold value into an analog judgment threshold value; and
a distortion-compensated-analog-signal judging unit that judges the distortion-compensated analog signal that is an output signal of the analog filter unit based on the analog judgment threshold value.

25. The distortion compensating equalizer according to claim 14, further comprising:
a tap-coefficient judging unit that judges a precision level of the estimation of the tap coefficient based on an evaluation function of the constant modulus algorithm for estimating the tap coefficient;
a judgment-reference-value calculating unit that calculates a judgment threshold value for a distortion-eliminated signal based on a result of judging the precision level of the estimation of the tap coefficient and the distortion-eliminated signal; and
a distortion-eliminated-signal judging unit that judges the distortion-eliminated signal based on the judgment threshold value, wherein
the equalizing unit further includes
a delay adjusting unit that adds a delay of predetermined time to a signal judged by the distortion-eliminated-signal judging unit;
a post-judgment digital filter unit that includes delay elements serially connected as many as taps, each of which sequentially adds a predetermined delay to an output signal from the delay adjusting unit, the post-judgment digital filter unit multiplying a delay-added signal output from each of the delay elements by a corresponding tap coefficient, adds all signals after the multiplication, and outputs a result of the addition; and
a distortion eliminating unit that eliminates a distortion from an output signal from the digital filter unit using an output signal from the post-judgment digital filter unit, and outputs a distortion-eliminated signal to the judgment-reference-value calculating unit and the distortion-eliminated-signal judging unit, and
the CMA-tap-coefficient estimating unit estimates tap coefficients of the digital filter unit and the post-judgment digital filter unit based on output signals from the distortion eliminating unit, the reception-signal adjusting unit, and the delay adjusting unit, and
the distortion in the waveform of the adjusted reception signal is compensated by repeating processes of the distortion eliminating unit, the distortion-eliminated-signal judging unit, the delay adjusting unit, the post-judgment digital filter unit, and the CMA-tap-coefficient estimating unit on the output signal from the digital filter unit.

26. The distortion compensating equalizer according to claim 25, further comprising:
an analog-reception-signal adjusting unit that adjusts a waveform of an analog reception signal in such a manner that an amplitude of the analog reception signal is equally distributed on a positive side and a negative side;
an analog-filter digital-to-analog converting unit that converts the tap coefficient, which is a digital value, of the digital filter unit estimated by the CMA-tap-coefficient estimating unit into an analog value;
an analog filter unit that realizes a same process as a process performed by the digital filter unit of the equalizing unit through an analog processing, using the adjusted analog reception signal and the analog-value-converted tap coefficient;
a threshold-value converting unit that converts the judgment threshold value into an judgment threshold value;
a distortion-eliminated analog signal judging unit that judges a distortion-eliminated analog signal based on the analog judgment threshold value;
a delay adjusting unit that adds a delay of predetermined time to a signal judged by the distortion-eliminated analog signal judging unit;
a post-judgment analog-filter digital-to-analog converting unit that converts the tap coefficient, which is a digital value, of the post-judgment digital filter unit estimated by the CMA-tap-coefficient estimating unit into an analog value;
a post-judgment analog filter unit that a same process as a process performed by the post-judgment digital filter unit of the equalizing unit, using an output signal from the delay adjusting unit and the analog-value-converted tap coefficient of the post-judgment analog filter unit; and
an analog distortion eliminating unit that eliminates a distortion from an output signal from the analog filter unit using an output signal from the post-judgment analog filter unit, and outputs a distortion-eliminated analog signal to the distortion-eliminated analog signal judging unit, wherein
a distortion in a waveform of the adjusted analog reception signal is compensated by repeating processes of the analog-filter digital-to-analog converting unit, the post-judgment analog-filter digital-to-analog converting unit, the analog filter unit, and the post-judgment analog filter unit.
